(19) United States
(12) Patent Application Publication
(10) Pub. No.: US 2009/0091917 A1
(43) Pub. Date: Apr. 9, 2009

(54) Switch attachment for visual enhancement

(76) Inventor: Chris Luginbuhl, Tolland, CT (US)

Correspondence Address: Alix, Yale & Ristas, LLP, 750 Main Street, Hartford, CT, 06103, US

(21) Appl. No.: 12/214,755

(22) Filed: Jun. 20, 2008

Related U.S. Application Data
(63) Continuation of application No. 10/202,512, filed on Jul. 23, 2002, now abandoned.
(60) Provisional application No. 60/307,203, filed on Jul. 23, 2001.

(51) Int. Cl. F21V 33/00

(52) U.S. Cl. 362/95

(57) ABSTRACT

A switch attachment for visual enhancement utilizing photoluminescent material. The invention incorporates photoluminescent material into devices for locating switches in low light conditions. The invention is embodied by attachments to switch assemblies, which utilize existing structures for attachment, or by the use of adhesives. The photoluminescent material is incorporated directly into the invention or is painted on or dyed.

### CROSS-REFERENCE TO RELATED APPLICATION

This application is a continuation of U.S. patent application Ser. No. 10/202,512 filed on Jul. 23, 2002 which claims the priority of U.S. Provisional Patent Application No. 60/307,203 filed on Jul. 23, 2001, the disclosures of which applications are incorporated herein in their entirety.

### BACKGROUND OF THE INVENTION

This invention relates generally to devices for locating switches. More particularly, this invention relates to devices for locating switches during dark and/or low light conditions.

A recurring problem of modern life is to readily locate switches, and particularly a light switch, when the surrounding area is dark. Conventional techniques which have been employed to assist in locating light switches have involved illuminating the switches with low level light and/or directing a low level light to the area of the switch panel. While such devices have functioned in an advantageous fashion to facilitate location of a switch during low light conditions, a principal deficiency for such devices resides in the fact that such switches require a constant current and, therefore, are not energy efficient. Another problem with such devices is that they do entail installation time and cost, which in some cases mitigates against employing such devices. The present invention generally incorporates materials, which have the property of photoluminescence. Photoluminescence is a property in which light exposure causes the material to fluoresce and/or phosphoresce. This photoluminescence property can cause materials to glow in the dark.

### SUMMARY OF THE INVENTION

Briefly stated, the invention in a preferred form is a new and improved device, which may be relatively easily mountable in conjunction with a light switch to provide a ready means for locating the switch in dark conditions through the use of photoluminescent materials.

Another object of the invention is to provide a new and improved means for readily locating a light switch during dark conditions which does not require electrical power or a battery power source since it incorporates the use of photoluminescent material.

Another object of the invention is to provide a new and improved device, which can be manufactured and installed in an efficient and low cost manner to provide a highly reliable device for locating a light switch.

The invention achieves the above stated objectives by the utilization of photoluminescent materials. The photoluminescent material may be molded or otherwise formed into structures that can be incorporated in or affixed to existing structures associated with switch assemblies. The photoluminescent material may also be painted, dyed, or otherwise coated or impregnated in or onto materials. The materials may be fixed through existing mechanical structure or adhesive means to the switch assembly.

### BRIEF DESCRIPTION OF THE DRAWINGS

FIG. 1 is a front view of one embodiment of a switch enhancement device installed on a light switch plate in accordance with the present invention.

FIG. 2 is a front view of a second embodiment of a switch enhancement device installed on a light switch plate in accordance with the present invention.

FIG. 3 is a front view of a third embodiment of a switch enhancement device installed on a light switch plate in accordance with the present invention.

FIG. 4 is a front view of a fourth embodiment of a switch enhancement device installed on a light switch plate in accordance with the present invention.

FIGS. 5a through 5c are front views of various designs of switch enhancement devices, each of which are installed on a light switch plate in accordance with the present invention.

FIGS. 6a through 6f are front views of various designs, each of which are installed on a portion of a light switch plate in accordance with the present invention.

FIGS. 7a and 7b are front views of animal designs, each of which can be installed on a portion of a light switch plate in accordance with the present invention.

FIGS. 8a and 8b are front views of a ships wheel design and a sign design carrying a trade name on it, each of which can be installed on a portion of a light switch plate in accordance with the present invention.

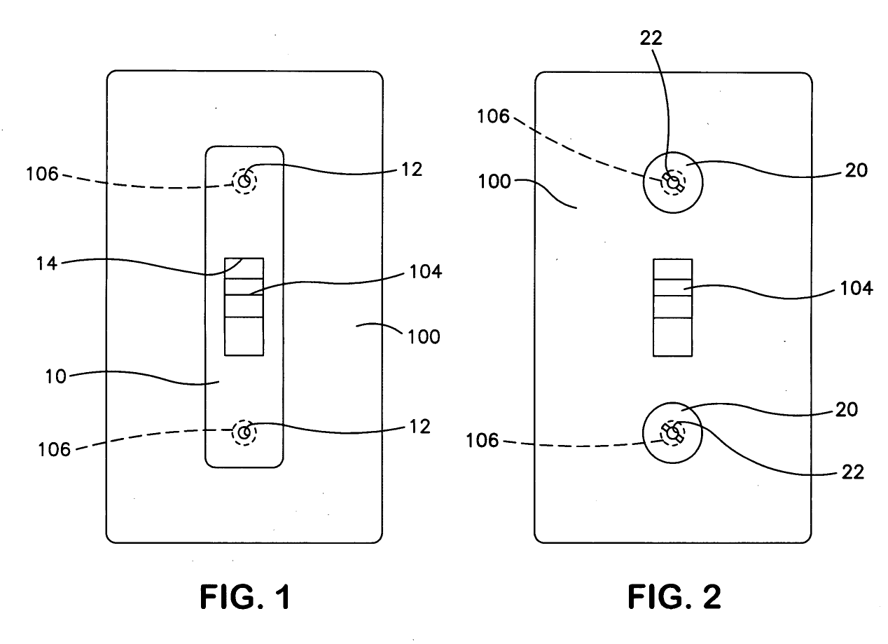

### DETAILED DESCRIPTION OF THE PREFERRED EMBODIMENTS

With reference to the drawings wherein like numerals represent like parts throughout the figures, a switch enhancement device in accordance with the present invention may be configured in several different embodiments. The inventive switch enhancement device is easily installed to an existing light switch and functions as a switch locator by emitting a glow without requiring any electrical power.

The switch device 10 in one preferred form is a plate, which replaces or slips over a conventional switch plate 100 which may have numerous forms and functions. It should be understood that switch plate 100 as illustrated is representative of numerous forms and configurations and should not be deemed a limitation of the invention. The plate 10 is made from a photoluminescent material. The switch plate 10 includes a pair of recessed openings 12 which are spaced a distance equal to the fastener openings 102 of the conventional switch plate 100. The switch plate 100 has an enlarged central aperture 14 which is dimensioned to slip over and around the conventional light switch toggle or actuator 104. The plate may be relatively easily mounted in place by removing the conventional threaded fasteners 106 which secure the switch plate 100 in position, inserting fasteners 106 through the openings 12 and securing the fasteners 106 to the threaded anchors (not illustrated) of the switch assembly.

With reference to FIG. 2, a second switch enhancement embodiment 20 is configured in the form of a flat circular disc or washer which includes a central opening 22. The conventional threaded screw 106 of the switch plate is removed and the fastener is inserted through the opening so that the fastener head captures the washer 20 and secures it in position against the switch plate 100. Preferably, two photoluminescent washers 20 are employed. This embodiment may be modified so that the area surrounding the central opening is shaped to resemble a variety of objects, such as but not limited to, animals, vehicles, structures, and the like.

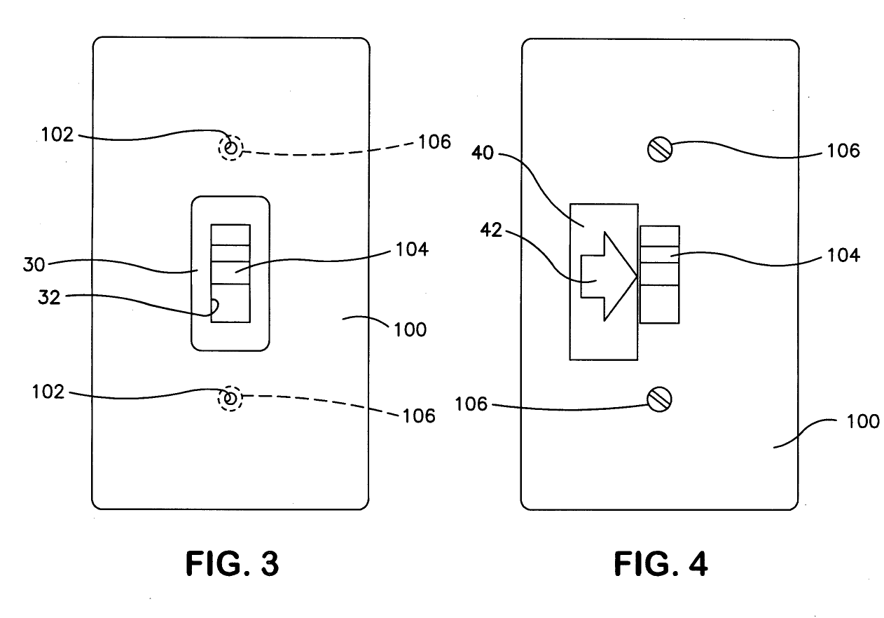

A third embodiment of a light switch enhancement device in accordance with the present invention is illustrated in FIG. 3 as device 30. Device 30 is also manufactured from photoluminescent material. The device 30 includes an adhesive backing (not illustrated) and is configured in a frame like structure which includes a central aperture 32 which fits around a conventional light switch toggle or actuator 104. The device 30 may be easily installed on the light switch by pressing it against the switch plate.

The composite material which may be employed for each of the embodiments 10, 20, 30 is a plastic material which contains a photoluminescent pigment. One such pigment is marketed under the LumiNova® name by United General and Chemical Corporation, 110 Valley Brook Avenue, Lindhurst, N.J. 07071. Such a pigment is added into the plastic material. During dark conditions, the material will glow and accordingly, the light switch may be located during dark conditions.

It will be appreciated that the locator device may also be formed into various additional devices such as zipper pulls and tags (not illustrated). The products may be injection-molded products which can be manufactured in a highly cost-effective manner.

With reference to FIG. 4, a fourth embodiment of the switch enhancement device 40 is a tape or film printed with photoluminescent ink and fastened to the switch plate by adhesive (not illustrated). The tape 40 may include arrows 42 or other locating indices formed by the photoluminescent ink.

Alternatively, the tape may also be printed with photoluminescent ink which forms a frame (with a cutout) to be placed around the switch actuator or toggle.

Alternatively, the switch plate 100 may be impregnated with photoluminescent pigments or a central rim of pigment around the inner circumferential border surrounding the switch toggle or actuator.

In one preferred embodiment the switch plate 100 may be formed from photoluminescent material or be painted or dyed with photoluminescent material.

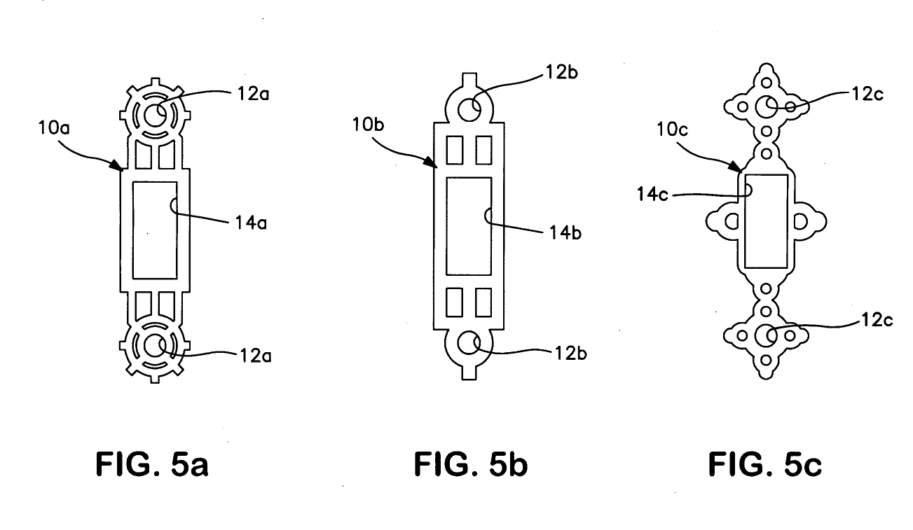

With reference to FIGS. 5a, 5b and 5c, a modified embodiment of switch device 10 may be configured in various fanciful design embodiments 10a, 10b and 10c these switch devices are each secured to the conventional switch plate via the switch plate fasteners 106. In this regard, each of the switch plates 10a, 10b and 10c includes an enlarged central aperture 14a, 14b and 14c which as mentioned, to slip over and around the conventional light switch toggle or actuator 104. In addition, each of switch plates 10a, 10b, and 10c includes a pair of recessed openings 12a, 12b and 12c, which are, spaced a distance equal to the fastener openings 102 of the conventional switch plate. Each of the switch devices 10a, 10b and 10c is formed from a photoluminescent material and therefore, facilitates location of the light switch.

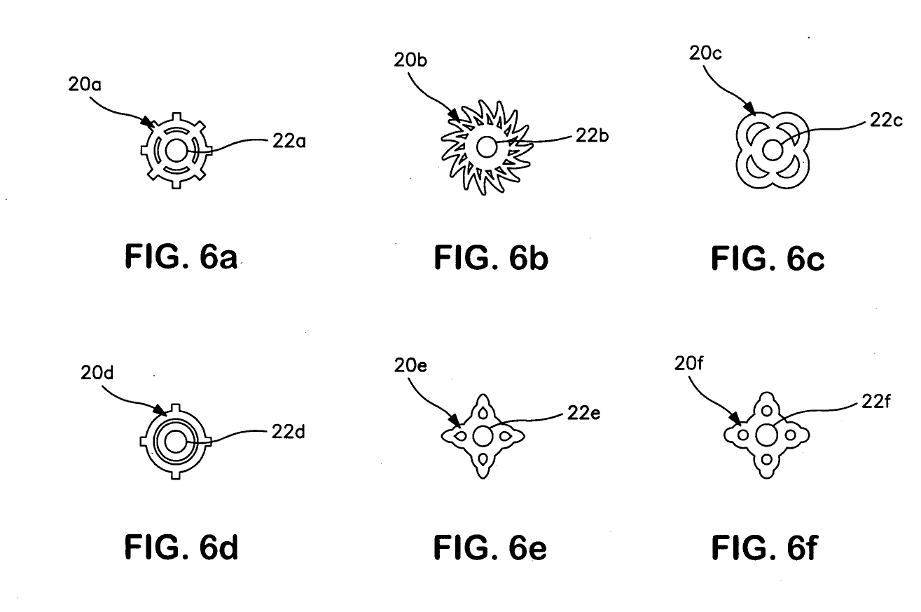

With reference to FIGS. 6a through 6f, switch enhancement embodiments 20a through 20f are similar in function to that of switch enhancement 20, but are further configured in the form of fanciful designs. Each of the switch enhancement devices includes a central opening 22a through 22f which is dimensioned to received the switch plate fastener for securing the locator device to the switch plate. The switch enhancement devices 6a through 6f are also formed from a photoluminescent material and accordingly, the devices also function to facilitate location of the switch.

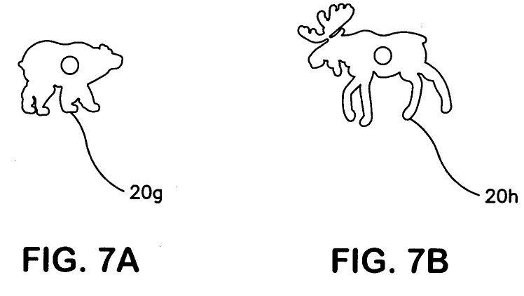

With reference to FIGS. 7a and 7b, switch enhancement embodiments 20g and 20h are similar in function to that of switch enhancement 20, but are further configured in the form of animal designs.

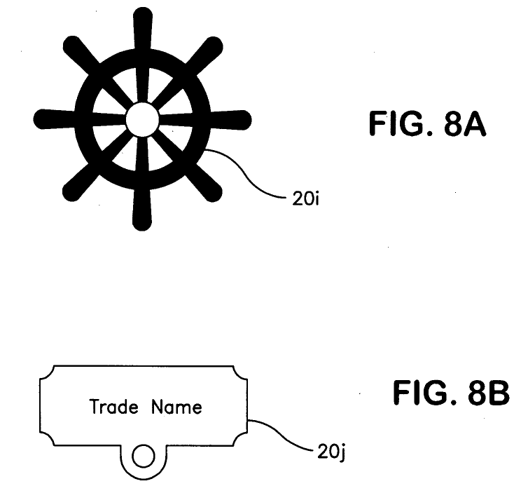

With reference to FIGS. 8a and 8b, switch enhancement embodiments 20i and 20j are similar in function to that of switch enhancement 20, but are further configured in the form of a ships wheel, 20i, and a sign bearing a trade name 20j.

It should be appreciated that numerous possible designs of the light switch enhancement devices in accordance with the present invention may be provided.

1. A method for visual enhancement of a switch assembly of a type comprising a switch plate defining a central opening for a switch actuator and at least one opening receiving a fastener for securing the plate to an underlying switch assembly comprising:
providing a second plate composed of plastic material having a photoluminescent pigment and wherein said second plate has an opening;
removing the at least one fastener from the switch plate;
placing the second plate against the switch plate; and
fastening the second plate against the switch plate by using the removed fastener so that said fastener secures the second plate concurrently to the switch plate and concurrently secures the switch plate to the switch assembly.

2. The method of claim 1, wherein said second plate has a second opening and the switch plate has second opening receiving a second fastener and further comprising:
removing the second fastener from the switch plate; and
fastening the second plate against the switch plate by using the removed second fastener to secure the second plate against the switch plate and secure the switch plate to the switch assembly.

3. The method of claim 1, wherein said switch plate remains in position against the switch assembly throughout the method.

4. The method of claim 1, wherein the second plate has a central opening and further comprising aligning said second plate central opening with said switch actuator.

5. A photoluminescent assembly comprising:
a switch assembly having a switch actuator and a pair of spaced threaded openings;
a switch plate covering said switch assembly defining a central opening for a switch actuator and a pair of spaced openings each for receiving a fastener;
a second plate composed of plastic having a photoluminescent material and mounted to cover a portion of said switch plate and defining at least one second plate opening aligned with one of said spaced switch plate openings; and
a fastener received in said second plate opening and said one spaced opening and threaded to a said threaded opening for securing said second plate against said switch plate and said switch plate to said switch assembly.

6. The photoluminescent assembly of claim 5, wherein the switch plate has non-photoluminescent symbols incorporated into it.

7. A photoluminescent assembly of claim 5, wherein the second plate has a photoluminescent coating and non-photoluminescent coating in the form of symbols.

8. The photoluminescent assembly of claim 5, wherein the second plate has a photoluminescent coating.

9. The photoluminescent assembly of claim 5, wherein the second plate has a frontal face and symbolic indicia is affixed to said face.

10. The photoluminescent assembly of claim 9, wherein the indicia comprises alphanumeric symbols.

11. The photoluminescent assembly of claim 5, wherein the second plate has an animal shape.

12. The photoluminescent assembly of claim 5, wherein the second plate has a ship's wheel shape.

13. The photoluminescent assembly of claim 5, wherein the second plate has an adhesive side and a photoluminescent side, and is at least partially configured with edges which form the shape of an arrow.

14. The photoluminescent assembly of claim 5, wherein said second plate is substantially rectangular.
